(19) United States
(12) Patent Application Publication
(10) Pub. No.: US 2026/0339778 A1
(43) Pub. Date: Oct. 29, 2026

(54) Distributed Processing of Large Language Models and Other Neural Network Workloads Using a Modular, Dynamically Reconfigurable Interconnection Fabric

(71) Applicant: TurboNext.ai Ltd., Singapore (SG)

(72) Inventors: Gene Ka-Ching Chui, Taipei (TW); Shang-Tse Chuang, Taipei (TW); Costas Calamvokis, Bath (GB); Zhi-Hern Loh, Singapore (SG); Kevin Lin, San Jose, CA (US); Kos Lin, Hsinchu (TW); Hang-Kaung Shu, Hsinchu (TW); Dan Cao, Singapore (SG)

(21) Appl. No.: 19/650,209

(22) Filed: Apr. 16, 2026

Related U.S. Application Data
(60) Provisional application No. 63/795,138, filed on Apr. 25, 2025.
(60) Provisional application No. 63/795,128, filed on Apr. 25, 2025.
(60) Provisional application No. 63/795,120, filed on Apr. 25, 2025.

(51) Int. Cl. G06F 11/10; G06F 11/07

(52) U.S. Cl. CPC G06F 11/1044; G06F 11/0721

(57) ABSTRACT

An inference processing system distributes language model inference across heterogeneous processing resources. A plurality of processing devices, each having a processing element and a local memory, are interconnected by an interconnection fabric. Each processing device stores a respective portion of session state data for an inference session in the local memory and performs an attention computation using the locally stored session state data to generate a local partial result. The local partial results are aggregated through the interconnection fabric by combining each local partial result with an incoming partial result from a preceding processing device to produce an accumulated partial result that is streamed to a succeeding processing device. The session state data remains in the local memory and does not traverse the interconnection fabric during aggregation. A final processing device outputs a fully accumulated attention result to one or more graphics processing units for feed-forward network computation.

### CROSS-REFERENCES TO RELATED APPLICATIONS

This application claims the benefit and priority of U.S. Provisional Application No. 63/795,138, filed Apr. 25, 2025, entitled “Distributed Processing of Large Language Models and Other Neural Network Workloads Using a Modular, Dynamically Reconfigurable Interconnection Fabric,” U.S. Provisional Application No. 63/795,128, filed Apr. 25, 2025, entitled “Transformer LLM Disaggregation for Heterogeneous Processing Units,” and U.S. Provisional Application No. 63/795,120, filed Apr. 25, 2025, entitled “System and Method for Physical Disaggregation of Memory and Compute in Large Language Model Serving,” each of which is hereby incorporated by reference herein in its entirety including all references and appendices cited therein, for all purposes, as if fully set forth herein.

This application is also related to U.S. Patent Application No. 19/647,709, filed Apr. 14, 2026 entitled “Transformer LLM Disaggregation for Heterogeneous Processing Units,” and U.S. Patent Application No. 19/648,861, filed Apr. 15, 2026, entitled “System and Method for Physical Disaggregation of Memory and Compute in Large Language Model Serving,” each of which is hereby incorporated by reference herein in its entirety including all references and appendices cited therein, for all purposes, as if fully set forth herein.

### FIELD

The present disclosure relates to distributed computing systems for language model inference, and more particularly to systems and methods for distributing attention computations across a plurality of processing devices interconnected by an interconnection fabric, each processing device comprising a local memory for storing key-value cache data, with feed-forward network computations performed by one or more graphics processing units.

### BACKGROUND

Language model inference presents a fundamental tension between computational intensity and memory bandwidth. During inference, a transformer model alternates between feed-forward network computations, which are compute-bound and demand high arithmetic throughput, and attention computations, which are memory-bound and demand high bandwidth access to key-value (KV) cache data accumulated over prior tokens in an inference session. Conventional inference pipelines execute both operations on compute processing units, storing KV caches in compute processing unit high-bandwidth memory (HBM) alongside model weights.

As language models scale to hundreds of billions of parameters and inference sessions accumulate KV caches spanning hundreds of thousands of tokens, the compute processing unit HBM capacity required to store both model weights and KV caches grows beyond what a single compute processing unit can provide. Conventional approaches address this scaling challenge by replicating KV caches across multiple compute processing units in a homogeneous cluster, shuttling KV cache data between solid-state drives, host dynamic random-access memory (DRAM), and compute processing unit HBM as sessions are activated and deactivated. These data transfers impose bandwidth demands measured in multiple terabytes per second and introduce latency that stalls compute processing unit compute units during memory-bound decode stages.

Alternative approaches employ static random-access memory (SRAM)-based custom inference chips that replace compute processing units entirely, but SRAM costs approximately one thousand dollars per gigabyte, and a single large language model deployment may require hundreds of chips to hold the necessary state. Disaggregated prefill and decode architectures split the two inference phases across separate hardware pools but still shuttle KV caches between storage tiers during the decode phase, incurring substantial inter-tier bandwidth overhead.

Conventional systems further require homogeneous compute processing unit clusters, preventing cost-effective reuse of older compute processing unit generations alongside newer hardware. A single model instance cannot span mixed-generation compute processing units without model duplication, constraining infrastructure flexibility and increasing capital expenditure as compute processing unit generations advance.

### SUMMARY

In accordance with one aspect, a method includes storing, in a local memory of each processing device of a plurality of processing devices interconnected by an interconnection fabric, a respective portion of session state data for an inference session, performing, at each processing device of the plurality of processing devices, an attention computation using the respective portion of the session state data stored in the local memory to generate a local partial result, aggregating the local partial results from the plurality of processing devices through the interconnection fabric to produce a fully accumulated attention result, wherein the respective portions of the session state data remain stored in the local memory and do not traverse the interconnection fabric during the aggregating, and outputting the fully accumulated attention result.

In some embodiments, each processing device of the plurality of processing devices comprises an application-specific integrated circuit (ASIC), the ASIC comprising a processing element configured to perform the attention computation.

In some embodiments, the aggregating includes combining, at each processing device of the plurality of processing devices, the local partial result with an incoming partial result received from a preceding processing device of the plurality of processing devices through the interconnection fabric to produce an accumulated partial result, and streaming the accumulated partial result from each processing device to a succeeding processing device of the plurality of processing devices through the interconnection fabric, wherein a final processing device of the plurality of processing devices outputs the fully accumulated attention result.

In some embodiments, the method further includes transmitting the fully accumulated attention result to one or more compute processing units and performing, via the one or more compute processing units, a feed-forward network computation using the fully accumulated attention result and model weights stored in a compute memory of the one or more compute processing units.

In some embodiments, the method further includes automatically detecting, via firmware executing on each ASIC, a topology of the interconnection fabric and populating a routing table on each ASIC based on the detected topology without host software intervention.

In some embodiments, the method further includes generating, at each processing device of the plurality of processing devices, an error-correcting code (ECC) for the accumulated partial result, and appending, at each processing device of the plurality of processing devices, a monotonically increasing sequence tag to the accumulated partial result prior to streaming the accumulated partial result to the succeeding processing device through the interconnection fabric.

In some embodiments, the method further includes, prior to the aggregating, writing a zeroed accumulator to a reserved memory region on a head processing device of the plurality of processing devices, resetting a sequence counter on the head processing device, and priming error-correcting code (ECC) bits for the zeroed accumulator via an ECC generator on the head processing device.

In accordance with another aspect, a system includes a plurality of application-specific integrated circuits (ASICs) interconnected by an interconnection fabric, each ASIC of the plurality of ASICs comprising a processing element and a local memory configured to store session state data for an inference session, firmware executing on each ASIC of the plurality of ASICs, the firmware configured to automatically detect a topology of the interconnection fabric and populate a routing table on each ASIC based on the detected topology without host software intervention, and one or more compute processing units communicatively coupled to the plurality of ASICs, the one or more compute processing units configured to store model weights in a compute memory and perform feed-forward network computations. Each ASIC of the plurality of ASICs is configured to perform, via the processing element, an attention computation using the session state data stored in the local memory to generate a local partial result, combine the local partial result with an incoming partial result received from a preceding ASIC through the interconnection fabric to produce an accumulated partial result, and stream the accumulated partial result to a succeeding ASIC through the interconnection fabric. A final ASIC of the plurality of ASICs is configured to output a fully accumulated attention result to the one or more compute processing units.

In some embodiments, each ASIC of the plurality of ASICs is further configured to generate an error-correcting code (ECC) for the accumulated partial result and append a monotonically increasing sequence tag to the accumulated partial result prior to streaming the accumulated partial result to the succeeding ASIC through the interconnection fabric.

In some embodiments, the firmware is further configured to execute a fault-tolerant handshake protocol that detects a failure in a node or a link segment of the interconnection fabric and reconfigures the routing table to bypass the node or the link segment associated with the failure.

In some embodiments, the interconnection fabric supports a plurality of configurable topologies including a daisy chain, a double daisy chain, a grid topology, and a star topology, and the firmware is configured to select a topology from the plurality of configurable topologies based on a physical link arrangement of the plurality of ASICs.

In some embodiments, each ASIC of the plurality of ASICs comprises one or more processing cores, each chiplet of the one or more processing cores integrating a processing element core and a plurality of memory channels coupled to the local memory, and a write dispatcher configured to arbitrate between writes originated by the one or more processing cores and incoming traffic received from an adjacent ASIC of the plurality of ASICs through the interconnection fabric.

In some embodiments, the system further includes a host scheduler configured to, prior to an inference iteration, write a zeroed accumulator to a reserved memory region on a head ASIC of the plurality of ASICs, reset a sequence counter on the head ASIC, and prime error-correcting code (ECC) bits for the zeroed accumulator via an ECC generator on the head ASIC.

In some embodiments, the plurality of ASICs are disposed within a layer-3 network switch chassis, the layer-3 network switch chassis configured to be installed within data center switching infrastructure.

In accordance with yet another aspect, a system includes a plurality of application-specific integrated circuits (ASICs) interconnected by an interconnection fabric, each ASIC of the plurality of ASICs comprising one or more processing cores and a write dispatcher, each chiplet of the one or more processing cores integrating a processing element core and a plurality of memory channels, the write dispatcher configured to arbitrate between writes originated by the one or more processing cores and incoming traffic received from an adjacent ASIC of the plurality of ASICs through the interconnection fabric, each ASIC of the plurality of ASICs further comprising a local memory coupled to the plurality of memory channels and configured to store session state data for an inference session, one or more compute processing units communicatively coupled to the plurality of ASICs via a communication interface, the one or more compute processing units configured to store model weights for a feed-forward network of a language model in a compute memory, and firmware stored on each ASIC of the plurality of ASICs, the firmware configured to detect a physical topology of the interconnection fabric, populate a routing table on each ASIC based on the detected physical topology without host software intervention, and execute a fault-tolerant handshake protocol that detects a failure in a node or a link segment of the interconnection fabric and reconfigures the routing table to bypass the node or the link segment associated with the failure. Each ASIC of the plurality of ASICs is configured to read the session state data from the local memory, perform via the one or more processing cores an attention computation on the session state data to generate a local partial result, generate an error-correcting code (ECC) for the local partial result, append a monotonically increasing sequence tag to the local partial result, combine the local partial result with an incoming partial result received from a preceding ASIC through the interconnection fabric to produce an accumulated partial result, verify an error-correcting code and a sequence tag associated with the incoming partial result, and stream the accumulated partial result to a succeeding ASIC through the interconnection fabric. A final ASIC of the plurality of ASICs is configured to output a fully accumulated attention result to the one or more compute processing units via the communication interface for a feed-forward network computation.

In some embodiments, the interconnection fabric supports a plurality of configurable topologies selected from the group consisting of a daisy chain, a double daisy chain, a grid topology, and a star topology.

In some embodiments, each ASIC of the plurality of ASICs is further configured to perform, via the one or more processing cores, one or more projection operations on compressed latent vectors received from the one or more compute processing units via the communication interface to produce decompressed data for an attention computation, the one or more projection operations reducing bandwidth consumption for data transfers between the one or more compute processing units and the plurality of ASICs.

In some embodiments, each ASIC of the plurality of ASICs is configured to batch the one or more projection operations across a plurality of concurrent inference sessions to amortize weight reads from the local memory.

In some embodiments, the system further includes a software abstraction layer executing on a host processor, the software abstraction layer configured to expose an application programming interface (API) that enables a single instance of the language model to operate across the plurality of ASICs and the one or more compute processing units without model duplication.

In some embodiments, the interconnection fabric comprises a double daisy chain providing two parallel data paths between each pair of adjacent ASICs of the plurality of ASICs.

### BRIEF DESCRIPTION OF THE DRAWINGS

FIG. 1 is a block diagram of an inference processing system according to an embodiment.

FIG. 2 is a block diagram of an internal architecture of a processing device of the inference processing system of FIG. 1 according to an embodiment.

FIG. 3 is a block diagram of a daisy chain topology of an interconnection fabric of the inference processing system of FIG. 1 according to an embodiment.

FIG. 4A is a block diagram of a first topology variant of the interconnection fabric according to an embodiment.

FIG. 4B is a block diagram of a second topology variant of the interconnection fabric according to an embodiment.

FIG. 4C is a block diagram of a third topology variant of the interconnection fabric according to an embodiment.

FIG. 4D is a block diagram of a fourth topology variant of the interconnection fabric according to an embodiment.

FIG. 5 is a data flow diagram of a distributed matrix multiplication operation across a plurality of processing devices according to an embodiment.

FIG. 6 is a flowchart of a method for distributed attention processing according to an embodiment.

FIG. 7 is a data flow diagram of a multi-latent attention projection offload according to an embodiment.

FIG. 8 is a diagrammatic representation of a computer system according to an embodiment.

### DETAILED DESCRIPTION OF EXAMPLE EMBODIMENTS

The following description sets forth various embodiments of a system and method for distributed processing of language model inference workloads. The embodiments described herein are provided by way of illustration and are not intended to limit the scope of the claims. In the following description, numerous specific details are set forth in order to provide a thorough understanding of the disclosed embodiments. One skilled in the art will recognize that variations and modifications may be made without departing from the spirit and scope of the disclosure.

As used herein, the term “processing element” refers to any computational unit configured to execute neural network operations, including but not limited to a neural processing unit (NPU), a tensor processing unit, a matrix computation engine, a digital signal processor configured for neural network workloads, or any other application-specific or general-purpose processor adapted for neural network computations. As used herein, the term “compute processing unit” refers to any computational unit configured to perform feed-forward network computations or other compute-bound neural network operations, including but not limited to a graphics processing unit (GPU), a central processing unit (CPU), a field-programmable gate array (FPGA), or any other processor adapted for compute-intensive workloads. As used herein, the term “session state data” refers to data maintained in a local memory for a given inference session, including but not limited to key-value (KV) cache data, intermediate activation data, compressed latent vectors, and any other per-session data consumed or produced during inference operations. As used herein, the term “processing core” refers to a discrete computational sub-unit within a processing device, including but not limited to a chiplet integrating a processing element and one or more memory channels. A processing device may comprise one or more processing cores. As used herein, the term “projection operation” refers to any linear or affine transformation applied to compressed or intermediate data to produce expanded or decompressed data for use in an attention computation, including but not limited to a key up-projection, a value up-projection, a query up-projection, a transposed key up-projection, a transposed value up-projection, a query NoPE up-projection, and any other projection on compressed latent vectors.

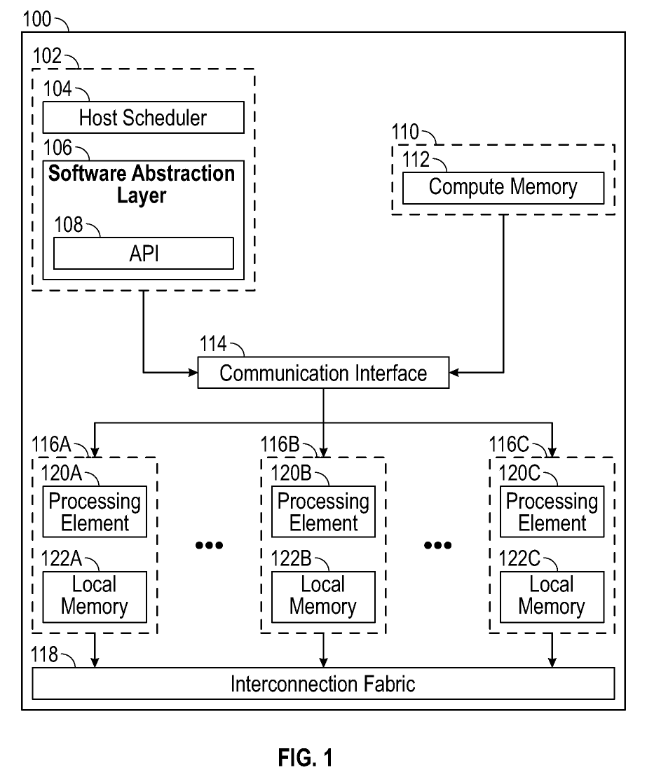

Referring to FIG. 1, an inference processing system 100 is shown according to an embodiment. The inference processing system 100 includes a host processor 102, a plurality of processing devices including a first processing device 116A, a second processing device 116B, and a third processing device 116C, one or more graphics processing units (GPUs) 110, and an interconnection fabric 118 interconnecting the first processing device 116A, the second processing device 116B, and the third processing device 116C. The inference processing system 100 is configured to distribute language model inference operations across heterogeneous processing resources, with memory-bound operations executing on the plurality of processing devices 116 and compute-bound operations executing on the one or more GPUs 110.

The host processor 102 of the inference processing system 100 executes a host scheduler 104 that manages the dispatch of inference tasks across the inference processing system 100. The host scheduler 104 coordinates the flow of data between the plurality of processing devices 116 and the one or more GPUs 110 during each inference iteration. In some embodiments, the host scheduler 104 selects batches of active user sessions, bundles current token vectors with corresponding session identifiers, and issues a write transaction over the communication interface 114 to dispatch the bundled data to a head processing device of the plurality of processing devices 116 for attention processing.

Continuing with FIG. 1, a software abstraction layer 106 executes on the host processor 102. The software abstraction layer 106 is configured to expose an application programming interface (API) 108 that enables a single instance of a language model to operate across the plurality of processing devices 116 and the one or more GPUs 110 without model duplication. The application programming interface (API) 108 of the software abstraction layer 106 provides a unified interface through which higher-level serving frameworks interact with the heterogeneous hardware of the inference processing system 100. In some embodiments, the software abstraction layer 106 integrates with serving stacks to decouple application-level logic from the underlying hardware topology, such that inference requests are routed transparently across the one or more GPUs 110 and the plurality of processing devices 116 regardless of hardware generation or vendor. In some embodiments, the software abstraction layer 106 integrates with a vLLM serving stack (versatile large language model), and the application programming interface (API) 108 conforms to an OpenAI-compliant API standard, enabling standardized request and response handling across diverse enterprise environments.

As shown in FIG. 1, the one or more graphics processing units (GPUs) 110 of the inference processing system 100 are configured to store model weights in a GPU memory 112 and perform feed-forward network computations. The GPU memory 112 of each GPU 110 stores model weights for a feed-forward network of a language model, and the one or more GPUs 110 perform feed-forward network computations using the model weights. Attention computations and associated state are offloaded to the plurality of processing devices 116. The one or more GPUs 110 are communicatively coupled to the plurality of processing devices 116 via a communication interface 114. The communication interface 114 provides a data path between the one or more GPUs 110 and the plurality of processing devices 116 for transferring activation vectors and attention outputs. In some embodiments, the communication interface 114 comprises a Peripheral Component Interconnect Express interface, an Ethernet interface, or another suitable interconnect technology.

Referring again to FIG. 1, the first processing device 116A, the second processing device 116B, and the third processing device 116C are interconnected by the interconnection fabric 118. Each processing device 116A, 116B, 116C comprises a respective neural processing unit (NPU) 120A, 120B, 120C and a respective local memory 122A, 122B, 122C. The neural processing unit (NPU) 120A, 120B, 120C of each processing device 116A, 116B, 116C is configured to perform an attention computation using key-value (KV) cache data stored in the respective local memory 122A, 122B, 122C to generate a local partial result. The local memory 122A, 122B, 122C of each processing device 116A, 116B, 116C stores a respective portion of the KV cache data for an inference session. In some embodiments, each processing device 116 comprises an application-specific integrated circuit (ASIC), and the local memory 122 comprises low-power double data rate (LPDDR) memory physically co-located with the ASIC.

The interconnection fabric 118 of the inference processing system 100 connects the plurality of processing devices 116 in a configurable topology. The interconnection fabric 118 carries partial results between adjacent processing devices 116 during distributed attention computations. In the embodiment of FIG. 1, the KV cache data stored in the local memory 122A, 122B, 122C of each processing device 116A, 116B, 116C remains in the respective local memory 122A, 122B, 122C and does not traverse the interconnection fabric 118 during aggregation of local partial results. By confining the KV cache data to the local memory 122 and restricting inter-device traffic on the interconnection fabric 118 to compact partial-result activation vectors, the inference processing system 100 reduces bandwidth demands compared to conventional GPU-based inference pipelines that shuttle KV caches between storage tiers.

As illustrated in FIG. 1, the inference processing system 100 operates by pinning each inference session's KV cache data in the local memory 122 distributed across the plurality of processing devices 116. During each inference iteration, each processing device 116A, 116B, 116C retrieves its respective portion of the KV cache data from the respective local memory 122A, 122B, 122C, performs the attention computation via the respective neural processing unit (NPU) 120A, 120B, 120C to generate a local partial result, and contributes the local partial result to a running accumulation that flows through the interconnection fabric 118 from the first processing device 116A to the third processing device 116C. The inference processing system 100 aggregates the local partial results from the plurality of processing devices 116 through the interconnection fabric 118 to produce a fully accumulated attention result, wherein the respective portions of the KV cache data remain stored in the local memory 122 and do not traverse the interconnection fabric 118 during the aggregating. A final processing device 116 of the plurality outputs the fully accumulated attention result to the one or more GPUs 110 via the communication interface 114, and the one or more GPUs 110 perform a feed-forward network computation using the fully accumulated attention result and the model weights stored in the GPU memory 112. The inference processing system 100 thereby dedicates the one or more GPUs 110 exclusively to compute-intensive feed-forward operations while the plurality of processing devices 116 handle memory-bound attention operations.

In some embodiments, each processing device 116 of the plurality of processing devices 116 executes a language model having an embedding dimension of 8,192 components, a vocabulary size of 32,000 tokens, a query projection dimension of 8,192, and key and value projection dimensions of 1,024, and a feed-forward network intermediate dimension of 28,672. The language model comprises a plurality of transformer layers, each transformer layer including root-mean-square normalization, a self-attention sub-layer with scaled dot-product attention, a residual connection, a second root-mean-square normalization, and a position-wise feed-forward network employing a SiLU activation function. In some embodiments, the language model is a Llama 70B model or another transformer-style large language model.

In an example deployment, the inference processing system 100 processes one million concurrent inference sessions, each inference session maintaining a context window of eight thousand tokens. A float16 key-value cache requires approximately 2.7 gigabytes per inference session, yielding an aggregate of approximately 2.7 petabytes of KV cache state across the one million concurrent inference sessions. Streaming that aggregate KV cache through the GPU memory 112 at typical decode rates would demand over three terabytes per second of interconnect bandwidth. By pinning the KV cache data in the local memory 122 distributed across the plurality of processing devices 116 and confining inter-device traffic on the interconnection fabric 118 to compact activation vectors, the inference processing system 100 eliminates multi-terabyte cache transfers, yielding four- to seven-fold higher tokens-per-second throughput, three- to seven-fold lower infrastructure costs, and more than three-fold reduced energy consumption compared to conventional GPU-based inference pipelines in large-scale multi-tenant benchmarks.

Unlike SRAM-based inference architectures, which incur high per-gigabyte memory costs and require extensive chip counts for large language models, the inference processing system 100 leverages cost-effective LPDDR5 memory resident on the plurality of processing devices 116 to achieve comparable memory bandwidth at a fraction of the cost. Unlike architectures that split pre-fill and decode stages but require moving KV caches between storage tiers, the inference processing system 100 pins the KV cache data in the local memory 122 of each processing device 116, eliminating multi-terabyte cache swaps and reducing interconnect bandwidth demands.

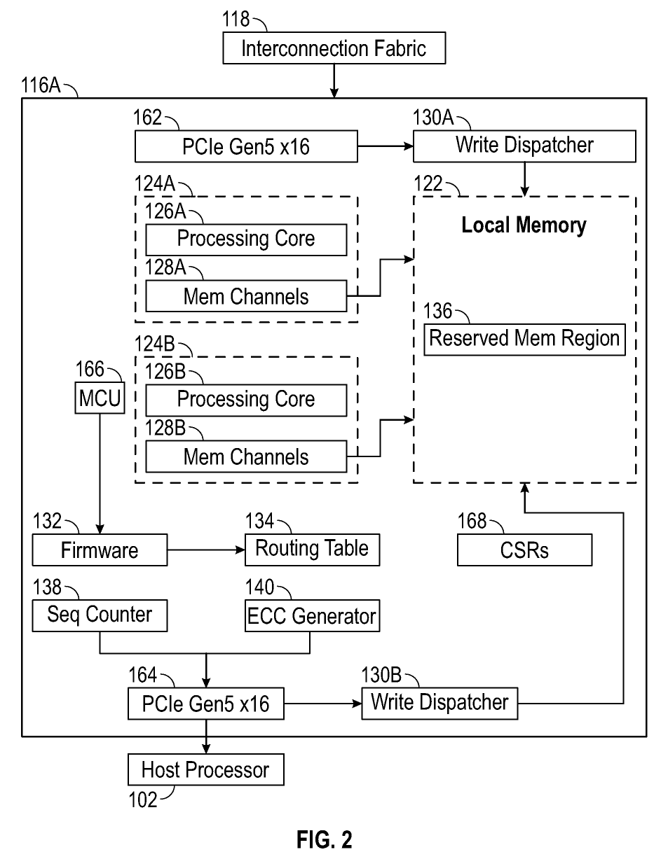

Turning to FIG. 2, the internal architecture of a single processing device 116 is shown in greater detail. In embodiments where each processing device 116 comprises an application-specific integrated circuit (ASIC), each ASIC of the plurality of processing devices 116 comprises a first chiplet 124A and a second chiplet 124B. The first chiplet 124A integrates a first NPU core 126A and a first plurality of memory channels 128A coupled to the local memory 122, and the second chiplet 124B integrates a second NPU core 126B and a second plurality of memory channels 128B coupled to the local memory 122. The NPU core 126A, 126B of each respective chiplet 124A, 124B executes neural network computations, including matrix-vector multiplications required for attention operations. Each NPU core 126 includes an internal static random-access memory (SRAM) scratchpad that serves as a low-latency staging buffer for weight tiles and activation fragments fetched from the local memory 122 via the plurality of memory channels 128. Each NPU core 126 further includes an Advanced eXtensible Interface (AXI) master port through which the NPU core 126 issues read requests to fetch model weights and KV cache data from the local memory 122 and write requests to store computed results back to the local memory 122. The plurality of memory channels 128 of each chiplet 124 provide high-bandwidth access to the local memory 122, enabling each chiplet 124 to read KV cache data and model weight shards from the local memory 122 at bandwidths sufficient to sustain the NPU core 126 throughput. In some embodiments, each chiplet 124 includes eight LPDDR5 memory channels providing approximately one hundred gigabytes per second of aggregate memory bandwidth, and the pair of chiplets 124 collectively provide sixteen memory channels per processing device 116.

As shown in FIG. 2, each processing device 116 further comprises a write dispatcher 130. The write dispatcher 130 is configured to arbitrate between writes originated by the pair of chiplets 124 and incoming traffic received from an adjacent processing device 116 of the plurality of processing devices 116 through the interconnection fabric 118. The write dispatcher 130 ensures that locally generated results from the pair of chiplets 124 and remotely received partial results from the interconnection fabric 118 are serialized and written to the local memory 122 without contention. In some embodiments, the write dispatcher 130 implements a priority-based arbitration scheme that gives precedence to incoming traffic from the interconnection fabric 118 to prevent stalling the streaming accumulation pipeline.

Continuing with FIG. 2, firmware 132 is stored on each processing device 116 of the plurality of processing devices 116. The firmware 132 is configured to automatically detect a physical topology of the interconnection fabric 118 and populate a routing table 134 on each processing device 116 based on the detected topology without host software intervention. The firmware 132 of each processing device 116 negotiates per-link widths and flow-control credit depths with adjacent processing devices 116, identifies the physical arrangement of the plurality of processing devices 116 within the interconnection fabric 118, and configures the routing table 134 to direct data flow accordingly. The routing table 134 on each processing device 116 stores forwarding entries that map destination identifiers to outgoing link ports. During topology detection, the firmware 132 on each processing device 116 transmits discovery frames on each active link port, receives response frames from adjacent processing devices 116, and assembles a neighbor table that records the identity and link parameters of each directly connected processing device 116. The firmware 132 then constructs the routing table 134 by computing forwarding paths based on the neighbor table, populating the routing table 134 with entries that direct outgoing traffic to the appropriate link port for each destination processing device 116. In some embodiments, the firmware 132 completes topology detection and routing table 134 population during a boot sequence, such that the plurality of processing devices 116 are ready for inference operations without requiring configuration commands from the host processor 102.

With reference to FIG. 2, the firmware 132 is further configured to execute a fault-tolerant handshake protocol that detects a failure in a node or a link segment of the interconnection fabric 118 and reconfigures the routing table 134 to bypass the node or the link segment associated with the failure. The fault-tolerant handshake protocol implemented by the firmware 132 operates by exchanging periodic heartbeat messages between adjacent processing devices 116 over each active link of the interconnection fabric 118. Each processing device 116 maintains a watchdog timer for each adjacent link; when a heartbeat response is not received within a configurable timeout period, the firmware 132 on the detecting processing device 116 marks the corresponding link segment or node as failed. Upon detecting a failure, the firmware 132 broadcasts a topology-change notification to all remaining processing devices 116 in the interconnection fabric 118, and each processing device 116 recalculates the routing table 134 to bypass the failed node or link segment. The reconfigured routing table 134 directs subsequent traffic around the failure while maintaining data flow across the remaining processing devices 116 in the interconnection fabric 118. In some embodiments, the firmware 132 attempts to re-establish communication with the failed node or link segment at periodic intervals, and upon successful re-establishment, the firmware 132 reintegrates the recovered node or link segment into the routing table 134.

Referring still to FIG. 2, each processing device 116 includes a reserved memory region 136 within the local memory 122. The reserved memory region 136 provides a dedicated address range within the local memory 122 for storing accumulator values during distributed computations. The reserved memory region 136 is sized to hold at least one complete accumulated partial result vector, and the address range of the reserved memory region 136 is configured by the firmware 132 during initialization. In some embodiments, prior to each inference iteration, the host scheduler 104 writes a zeroed accumulator to the reserved memory region 136 on a head processing device of the plurality of processing devices 116, priming the reserved memory region 136 with a known initial value from which the accumulation proceeds. In some embodiments, the zeroed accumulator comprises a two-element float16 vector stored at a dedicated address range within the reserved memory region 136.

Each processing device 116 further includes a sequence counter 138. The sequence counter 138 maintains a monotonically increasing count value that is appended to each outgoing accumulated partial result as a sequence tag before the accumulated partial result is streamed to the succeeding processing device 116 through the interconnection fabric 118. The sequence counter 138 enables the receiving processing device 116 to verify that incoming partial results arrive in the correct order and that no partial results have been dropped or duplicated during transit through the interconnection fabric 118. Prior to each inference iteration, the host scheduler 104 resets the sequence counter 138 on the head processing device to a starting value.

Each processing device 116 further includes an ECC generator 140. The ECC generator 140 computes an error-correcting code over each outgoing accumulated partial result before the accumulated partial result is streamed to the succeeding processing device 116 through the interconnection fabric 118. The receiving processing device 116 verifies the error-correcting code to detect and, where possible, correct bit errors introduced during transit. Prior to each inference iteration, the host scheduler 104 primes error-correcting code (ECC) bits for the zeroed accumulator stored in the reserved memory region 136 via the ECC generator 140 on the head processing device, ensuring that the initial accumulated partial result carries valid error-correcting code data from the start of the chain.

As further shown in FIG. 2, each processing device 116 includes a first Peripheral Component Interconnect Express (PCIe) interface 162 and a second PCIe interface 164. In some embodiments, the first PCIe interface 162 and the second PCIe interface 164 each conform to the PCIe Generation 5 standard and provide sixteen lanes (PCIe Gen5 x16). The first PCIe interface 162 of each processing device 116 connects to a preceding processing device 116 or to the host processor 102, and the second PCIe interface 164 of each processing device 116 connects to a succeeding processing device 116 in the daisy chain arrangement of the interconnection fabric 118. Each PCIe interface 162, 164 includes an AXI slave port and an AXI master port. The AXI slave port of each PCIe interface 162, 164 receives incoming read and write transactions from the adjacent processing device 116 or the host processor 102, and the AXI master port of each PCIe interface 162, 164 initiates outgoing read and write transactions toward the adjacent processing device 116 or the host processor 102. The first PCIe interface 162 and the second PCIe interface 164 collectively provide bidirectional connectivity that forms the physical basis of the daisy chain topology of the interconnection fabric 118.

Continuing with FIG. 2, in embodiments where each processing device 116 includes the first PCIe interface 162 and the second PCIe interface 164, each processing device 116 comprises a first write dispatcher 130A associated with the first PCIe interface 162 and a second write dispatcher 130B associated with the second PCIe interface 164. The first write dispatcher 130A arbitrates between writes originated by the first chiplet 124A and the second chiplet 124B and incoming traffic received through the first PCIe interface 162. The second write dispatcher 130B arbitrates between writes originated by the first chiplet 124A and the second chiplet 124B and incoming traffic received through the second PCIe interface 164. Each write dispatcher serializes locally generated results and remotely received partial results and writes the serialized data to the local memory 122 without contention. In some embodiments, each write dispatcher implements a priority-based arbitration scheme that gives precedence to incoming traffic from the respective PCIe interface 162, 164 to prevent stalling the streaming accumulation pipeline.

Referring again to FIG. 2, each processing device 116 further includes a microcontroller unit (MCU) 166. The microcontroller unit (MCU) 166 is a discrete processing element on the processing device 116 that is separate from the neural processing unit (NPU) 120 and the NPU core 126 of each chiplet 124. The firmware 132 executes on the microcontroller unit (MCU) 166. The microcontroller unit (MCU) 166 performs boot-time initialization of the processing device 116, executes the topology detection and routing table 134 population described above, manages the fault-tolerant handshake protocol, and handles configuration of control and status registers (CSRs) 168 on the processing device 116.

As further illustrated in FIG. 2, each processing device 116 includes a set of control and status registers (CSRs) 168. The control and status registers (CSRs) 168 are accessible to the microcontroller unit (MCU) 166 and to the host processor 102 via the first PCIe interface 162 or the second PCIe interface 164. The control and status registers (CSRs) 168 store configuration parameters for the neural processing unit (NPU) 120, the write dispatcher 130, the sequence counter 138, the ECC generator 140, and the firmware 132. In some embodiments, the host processor 102 writes configuration values to the control and status registers (CSRs) 168 during system initialization to set operating modes, and the microcontroller unit (MCU) 166 reads the control and status registers (CSRs) 168 during the boot sequence to configure the processing device 116 for inference operations.

With continued reference to FIG. 2, in some embodiments, the inference processing system 100 resides on a single printed circuit board (PCB) card, and the plurality of processing devices 116 and the one or more GPUs 110 are mounted on the single card. In other embodiments, the inference processing system 100 spans multiple cards, with a first subset of the plurality of processing devices 116 disposed on a first card and a second subset of the plurality of processing devices 116 disposed on a second card, and the interconnection fabric 118 extends across a card-to-card connector between the first card and the second card. The modular card-based arrangement supports elastic resource allocation, in which additional processing devices 116 are integrated into the interconnection fabric 118 as computational demand grows, and the firmware 132 on each processing device 116 automatically detects the newly added processing devices 116 through the topology detection process and updates the routing table 134 accordingly.

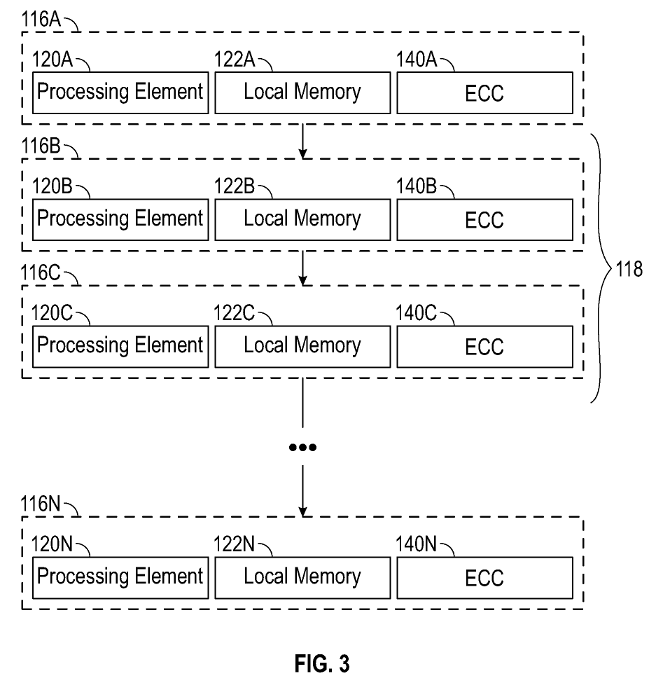

Referring to FIG. 3, a daisy chain embodiment of the interconnection fabric 118 is shown. In the daisy chain embodiment, the interconnection fabric 118 is formed by serial links between adjacent processing devices such that a first processing device 116A, a second processing device 116B, a third processing device 116C, and additional processing devices through an Nth processing device 116N are connected in a serial arrangement, with each processing device 116A through 116N linked to an immediately preceding processing device and an immediately succeeding processing device through the interconnection fabric 118. The first processing device 116A occupies the head position in the serial arrangement and receives initial input data from the host processor 102 via the communication interface 114. In embodiments where each processing device 116A through 116N comprises an ASIC, the first processing device 116A is referred to as a head ASIC of the plurality of ASICs. Each subsequent processing device 116B through 116N in the chain receives an incoming partial result from the preceding processing device through the interconnection fabric 118, performs its own local attention computation via the respective neural processing unit (NPU) 120A through 120N using KV cache data stored in the respective local memory 122A through 122N, and combines the local partial result with the incoming partial result to produce an accumulated partial result. The accumulated partial result is streamed from each processing device 116A through 116N to the succeeding processing device through the interconnection fabric 118. The Nth processing device 116N outputs the fully accumulated attention result after incorporating its own local partial result.

As shown in FIG. 3, each processing device 116A through 116N in the daisy chain generates an error-correcting code (ECC) for the accumulated partial result via the respective ECC generator 140A through 140N. Each processing device 116 further appends a monotonically increasing sequence tag via the sequence counter 138 (shown in FIG. 2) to the accumulated partial result prior to streaming the accumulated partial result to the succeeding processing device 116 through the interconnection fabric 118. The receiving processing device 116 verifies the error-correcting code and the sequence tag associated with the incoming partial result before combining the incoming partial result with its own local partial result. The monotonically increasing sequence tags guarantee byte-level ordering across the chain of processing devices 116, and the error-correcting codes provide immediate link-error detection at each hop through the interconnection fabric 118.

Continuing with FIG. 3, the daisy chain topology enables distributed matrix multiplication across the plurality of processing devices 116 without requiring global data broadcasts. Each processing device 116 holds a respective partition of the attention weight matrix in the local memory 122, computes a local matrix-vector product using the NPU core 126, and adds the local product to the running accumulation received from the preceding processing device 116. Because each processing device 116 reads its weight partition and KV cache data from the local memory 122, the interconnection fabric 118 carries only compact activation vectors and accumulated partial results, rather than full weight matrices or KV caches. In some embodiments, the interconnection fabric 118 in the daisy chain topology comprises PCIe Gen5 x16 links between adjacent processing devices 116, and each processing device 116 connects to the immediately preceding processing device through the first PCIe interface 162 and to the immediately succeeding processing device through the second PCIe interface 164. In some embodiments, the host scheduler 104 partitions workloads across the plurality of processing devices 116 according to the availability and performance capabilities of each processing device 116, such that processing devices 116 with larger local memory 122 capacity or higher NPU core 126 throughput receive proportionally larger weight partitions.

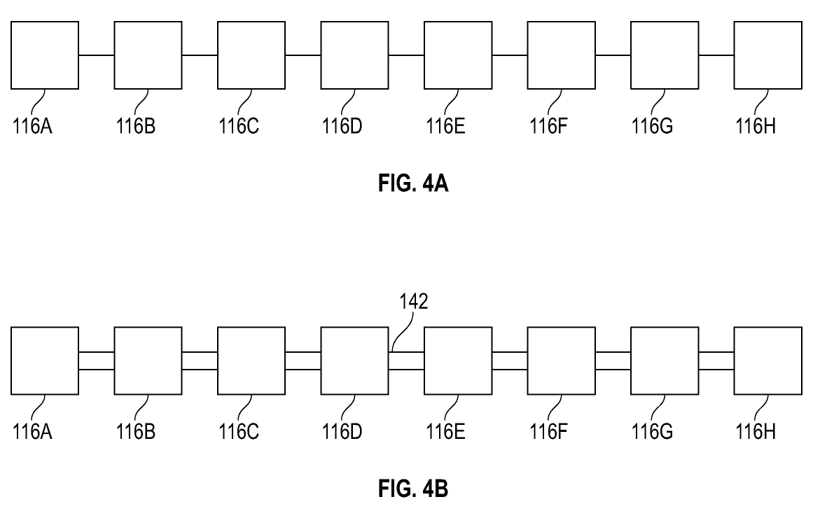

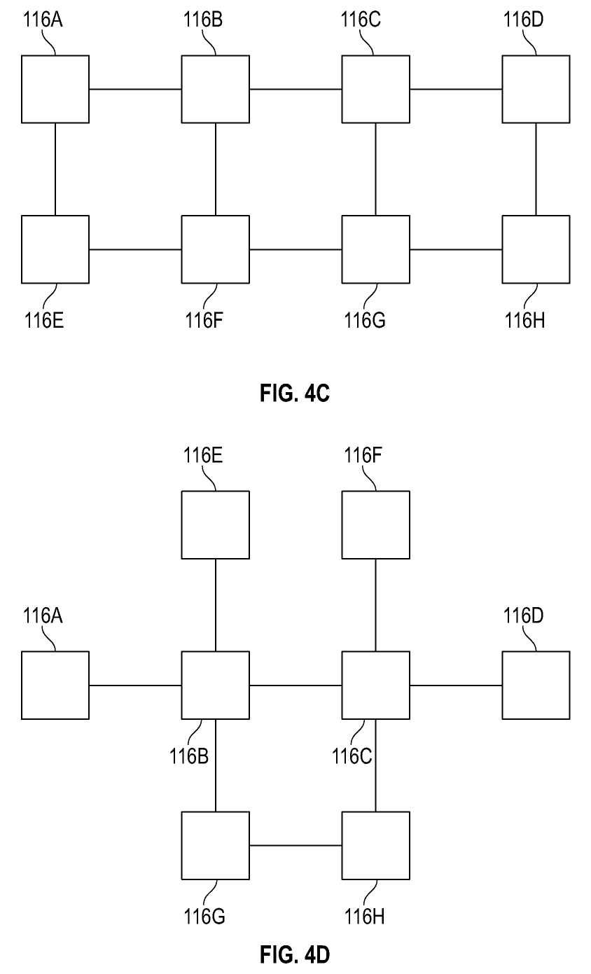

Referring to FIGS. 4A through 4D, the interconnection fabric 118 supports a plurality of configurable topologies including a daisy chain, a double daisy chain, a grid topology, and a star topology. The firmware 132 is configured to select a topology from the plurality of configurable topologies based on a physical link arrangement of the plurality of processing devices 116. In the embodiments of FIGS. 4A through 4D, four topology variants are shown using a set of eight processing devices 116A, 116B, 116C, 116D, 116E, 116F, 116G, and 116H. One of ordinary skill in the art will appreciate that the topologies described herein apply to any number of processing devices 116, and eight processing devices are shown for purposes of illustration.

Referring to FIG. 4A, a first topology variant is shown in which the processing devices 116A through 116H are arranged in a single daisy chain, as described above with respect to FIG. 3. Each processing device 116A through 116H connects to the immediately adjacent processing device through a single link of the interconnection fabric 118. The first processing device 116A in the chain receives input from the host processor 102 via the communication interface 114.

Referring to FIG. 4B, a second topology variant is shown in which the interconnection fabric 118 comprises a double daisy chain providing two parallel data paths 142 between each pair of adjacent processing devices 116A through 116H. The parallel data paths 142 of the double daisy chain increase available bandwidth between adjacent processing devices 116A through 116H, enabling higher throughput for partial result transfers through the interconnection fabric 118. In some embodiments, each processing device 116A through 116H includes four physical link ports, and the double daisy chain allocates two link ports per direction to establish the two parallel data paths 142 between each pair of adjacent processing devices.

Referring to FIG. 4C, a third topology variant is shown in which the processing devices 116A through 116H are arranged in a grid topology having a first row of four processing devices 116A, 116B, 116C, 116D and a second row of four processing devices 116E, 116F, 116G, 116H. Each processing device in the first row connects to the horizontally adjacent processing device in the first row through a link of the interconnection fabric 118, and each processing device in the second row connects to the horizontally adjacent processing device in the second row through a link of the interconnection fabric 118. Each processing device in the first row further connects to the vertically corresponding processing device in the second row through a link of the interconnection fabric 118. The grid topology establishes cross-links between non-adjacent processing devices, reducing the maximum hop count between any two processing devices compared to the single daisy chain. The reduced hop count of the grid topology decreases latency for accumulation operations that span the full set of processing devices 116A through 116H.

Referring to FIG. 4D, a fourth topology variant is shown in which the processing devices 116A through 116H are arranged in a star topology. A center row of processing devices 116A, 116B, 116C, 116D connects in a horizontal chain through the interconnection fabric 118. An upper pair of processing devices 116E, 116F connects to the center row, with the processing device 116E connecting to the processing device 116B and the processing device 116F connecting to the processing device 116C. A lower pair of processing devices 116G, 116H connects to the center row, with the processing device 116G connecting to the processing device 116B and the processing device 116H connecting to the processing device 116C. The star topology provides a hub-and-spoke arrangement in which the central processing devices 116B and 116C serve as hubs, and the peripheral processing devices 116A, 116D, 116E, 116F, 116G, and 116H connect as spokes. The star topology may be selected by the firmware 132 when the physical link arrangement of the processing devices 116A through 116H favors a centralized routing path.

In some embodiments, the processing devices 116 are disposed within a layer-3 network switch chassis. The layer-3 network switch chassis is configured to be installed within data center switching infrastructure. The layer-3 network switch chassis provides a modular form factor in which the plurality of processing devices 116 occupy line card slots alongside conventional network line cards, enabling inference acceleration as a built-in feature of existing network infrastructure. The layer-3 network switch chassis provides high-bandwidth, low-latency, non-blocking fabric connectivity between the processing devices 116 and between the processing devices 116 and the one or more GPUs 110 connected to the data center network.

In various embodiments, the interconnection fabric 118 is implemented using one or more physical interconnect technologies. In some embodiments, the interconnection fabric 118 comprises PCIe Gen5 x16 links between adjacent processing devices 116 as described above. In other embodiments, the interconnection fabric 118 comprises a non-blocking PCIe switch fabric in which a PCIe switch provides any-to-any connectivity among the plurality of processing devices 116. In still other embodiments, the interconnection fabric 118 comprises a shared PCIe backplane on which the plurality of processing devices 116 communicate via a common bus. In further embodiments, the interconnection fabric 118 comprises a 100 gigabit Ethernet (100 GbE) network or an InfiniBand network interconnecting the plurality of processing devices 116. The firmware 132 on each processing device 116 is configured to detect which physical interconnect technology is present and to configure the routing table 134 and error-correcting code parameters accordingly, such that every intermediate tensor arrives at the correct downstream processing device 116 without host software intervention.

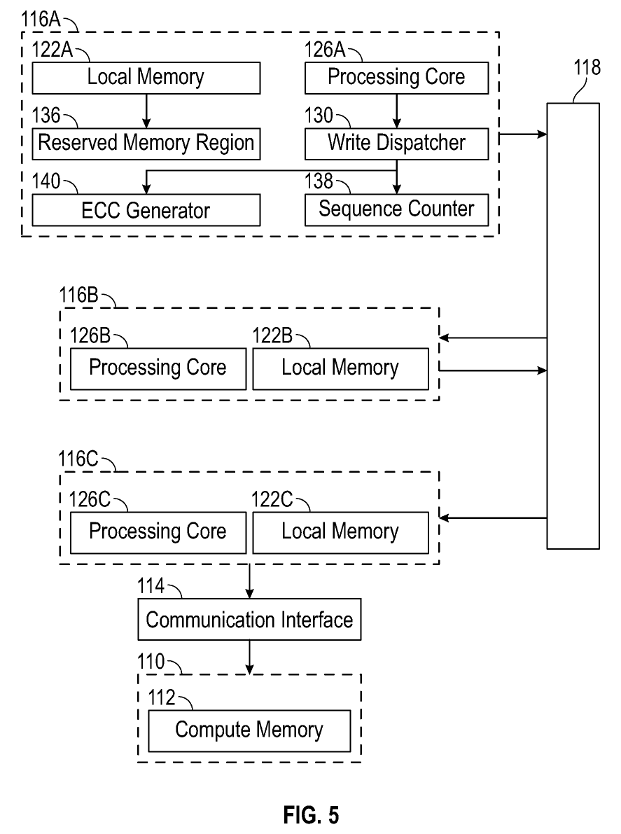

Turning to FIG. 5, a distributed matrix multiplication operation across the plurality of processing devices 116 is shown in a data flow representation. In the embodiment of FIG. 5, the plurality of processing devices includes a first processing device 116A, a second processing device 116B, and a third processing device 116C, each having a respective NPU core 126A, 126B, 126C and a respective local memory 122A, 122B, 122C. An activation matrix and a weight matrix are each partitioned into sub-matrices distributed across the first processing device 116A, the second processing device 116B, and the third processing device 116C. Each processing device 116A, 116B, 116C stores its assigned sub-matrix pair in the respective local memory 122A, 122B, 122C and performs a local matrix multiplication via the respective NPU core 126A, 126B, 126C, yielding a local partial result.

As shown in FIG. 5, the head processing device 116A of the plurality of processing devices 116 computes its local partial result and writes the local partial result as an initial accumulated partial result to the reserved memory region 136 via the write dispatcher 130. The ECC generator 140 of the head processing device generates an error-correcting code for the initial accumulated partial result, and the sequence counter 138 appends a sequence tag. The initial accumulated partial result, together with the error-correcting code and the sequence tag, is streamed to the next processing device 116 through the interconnection fabric 118.

Referring again to FIG. 5, at each successive processing device 116 in the chain, the write dispatcher 130 receives the incoming accumulated partial result from the interconnection fabric 118, and the processing device 116 verifies the error-correcting code and the sequence tag associated with the incoming accumulated partial result. The NPU core 126 of the processing device 116 computes its own local partial result from the locally stored sub-matrices, and the processing device 116 combines the local partial result with the incoming accumulated partial result to produce an updated accumulated partial result. The ECC generator 140 generates a fresh error-correcting code for the updated accumulated partial result, and the sequence counter 138 increments and appends a new sequence tag. The updated accumulated partial result is streamed to the succeeding processing device 116 through the interconnection fabric 118.

Continuing with FIG. 5, when the accumulated partial result reaches the final processing device 116 of the plurality, the final processing device 116 incorporates its own local partial result into the accumulated partial result to produce the fully accumulated attention result. The fully accumulated attention result represents the complete matrix multiplication product across all partitions distributed among the plurality of processing devices 116. The final processing device 116 outputs the fully accumulated attention result to the one or more GPUs 110 via the communication interface 114 for subsequent feed-forward network computation.

As illustrated in FIG. 5, the distributed matrix multiplication leverages the daisy chain arrangement of the interconnection fabric 118 to stream partial results in place. Each processing device 116 reads its activation and weight sub-matrices from the local memory 122, and the interconnection fabric 118 carries only the incrementally accumulated partial result vector from one processing device 116 to the next. The fully accumulated attention result emerges at the end of the chain without any global broadcast or all-to-all reduction across the plurality of processing devices 116. In some embodiments, the inference processing system 100 includes sixteen processing devices 116 arranged in the daisy chain topology, and the activation matrix is column-partitioned across the sixteen processing devices 116 while the weight matrix is row-partitioned across the sixteen processing devices 116. Each processing device 116 performs a local matrix multiplication of its assigned column partition of the activation matrix and its assigned row partition of the weight matrix, and the accumulated partial result flows from a first processing device 116 through to a sixteenth processing device 116, which produces the fully accumulated attention result representing the complete matrix product.

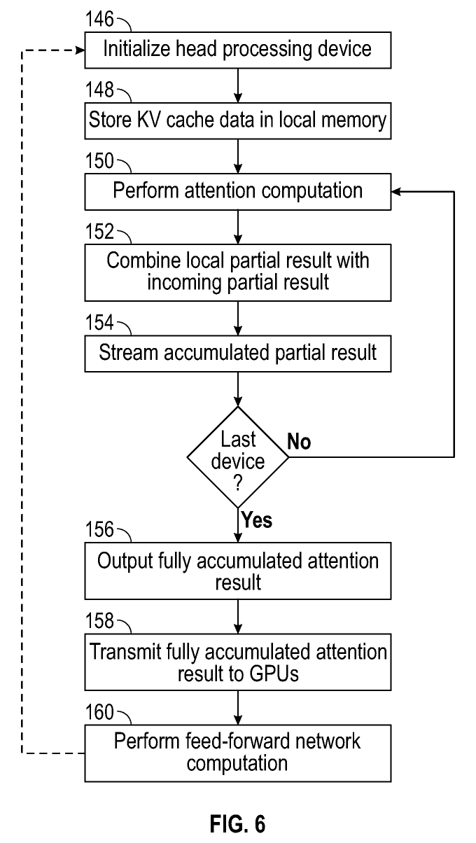

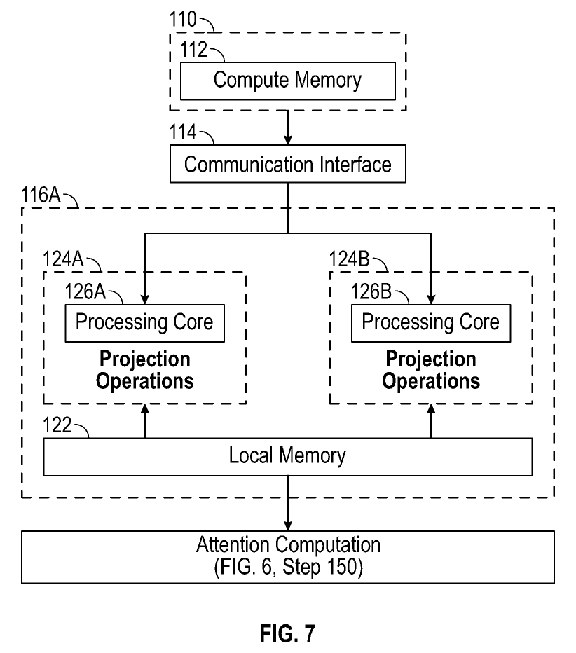

Referring to FIG. 6, a flowchart illustrates a method for distributed attention processing across the plurality of processing devices 116 in cooperation with the one or more GPUs 110. The method begins at step 146, in which the host scheduler 104 initializes a head processing device of the plurality of processing devices 116. In step 146, the host scheduler 104 writes a zeroed accumulator to the reserved memory region 136 on the head processing device, resets the sequence counter 138 on the head processing device, and primes error-correcting code (ECC) bits for the zeroed accumulator via the ECC generator 140 on the head processing device.

In step 148, the method includes storing, in the local memory 122 of each processing device 116 of the plurality of processing devices 116, a respective portion of key-value (KV) cache data for an inference session. The local memory 122 of each processing device 116 retains the respective portion of the KV cache data across inference iterations, such that the KV cache data does not traverse the interconnection fabric 118 and is not copied to the GPU memory 112.

As shown in FIG. 6, in step 150, the method includes performing, at each processing device 116 of the plurality of processing devices 116, an attention computation using the respective portion of the KV cache data stored in the local memory 122 to generate a local partial result. Each processing device 116 reads its respective portion of the KV cache data from the local memory 122 and retrieves its shard of the attention weight matrix. The neural processing unit (NPU) 120 of each processing device 116 executes the matrix-vector multiplication between the token activation vector and the locally stored weight shard to compute the local partial result.

Continuing with FIG. 6, in step 152, the method includes combining, at each processing device 116 of the plurality of processing devices 116, the local partial result with an incoming partial result received from a preceding processing device 116 of the plurality of processing devices 116 through the interconnection fabric 118 to produce an accumulated partial result. At the head processing device, the incoming partial result is the zeroed accumulator written in step 146. At each subsequent processing device 116, the incoming partial result is the accumulated partial result received from the immediately preceding processing device 116.

In step 154, the method includes streaming the accumulated partial result from each processing device 116 to a succeeding processing device 116 of the plurality of processing devices 116 through the interconnection fabric 118. Prior to streaming, each processing device 116 generates an error-correcting code (ECC) for the accumulated partial result via the ECC generator 140 and appends a monotonically increasing sequence tag via the sequence counter 138 to the accumulated partial result. Steps 152 and 154 repeat at each successive processing device 116 in the chain until the accumulated partial result reaches the final processing device 116.

Referring again to FIG. 6, in step 156, the method includes outputting the fully accumulated attention result. A final processing device 116 of the plurality of processing devices 116 combines its own local partial result with the incoming accumulated partial result to produce the fully accumulated attention result and outputs the fully accumulated attention result.

In step 158, the method includes transmitting the fully accumulated attention result to the one or more graphics processing units (GPUs) 110. The final processing device 116 writes the fully accumulated attention result into an outbound direct memory access (DMA) buffer and transfers the fully accumulated attention result to the one or more GPUs 110 via the communication interface 114. In some embodiments, the final processing device 116 raises an interrupt to signal the one or more GPUs 110 that the fully accumulated attention result is available. A waiting thread on the one or more GPUs 110 fetches the fully accumulated attention result from the outbound DMA buffer, appends the fully accumulated attention result to feed-forward inputs already resident in the GPU memory 112, and launches the feed-forward network computation without pipeline stalls.

As shown in FIG. 6, in step 160, the method includes performing, via the one or more GPUs 110, a feed-forward network computation using the fully accumulated attention result and model weights stored in the GPU memory 112 of the one or more GPUs 110. Upon receiving the fully accumulated attention result, the one or more GPUs 110 execute the feed-forward layers of the language model, producing output activations for subsequent processing or token generation. After step 160, the final processing device 116 clears its accumulator in the reserved memory region 136, resets the sequence counter 138 to an idle state, and signals the head processing device that the chain is ready for a next decode iteration. The method may then return to step 146 for the next inference iteration, in which the host scheduler 104 reinitializes the head processing device by writing a zeroed accumulator to the reserved memory region 136, resetting the sequence counter 138, and priming the ECC bits via the ECC generator 140.

Turning to FIG. 7, a data flow diagram illustrates a multi-latent attention (MLA) projection offload according to an embodiment. As shown in FIG. 7, a processing device 116A of the plurality of processing devices 116 comprises a first chiplet 124A and a second chiplet 124B, each having a respective NPU core 126A, 126B. In embodiments that employ a multi-latent attention architecture, each processing device 116 of the plurality of processing devices 116 is configured to perform, via the first chiplet 124A and the second chiplet 124B, one or more projection operations on compressed latent vectors received from the one or more GPUs 110 via the communication interface 114 to produce decompressed data for an attention computation. The one or more projection operations reduce bandwidth consumption for data transfers between the one or more GPUs 110 and the plurality of processing devices 116 by transmitting compact compressed latent vectors over the communication interface 114 rather than full-dimension tensors.

As shown in FIG. 7, the one or more GPUs 110 generate compressed latent vectors from input activations and transmit the compressed latent vectors to the plurality of processing devices 116 via the communication interface 114. Each processing device 116 receives the compressed latent vectors and performs the one or more projection operations locally using projection weight matrices stored in the local memory 122. The NPU core 126A, 126B of each respective chiplet 124A, 124B executes the projection operations to expand the compressed latent vectors into decompressed data used for the attention computation described with respect to FIG. 6. In some embodiments, the one or more projection operations include a key up-projection and a value up-projection. In other embodiments, the one or more projection operations include a transposed key up-projection, a transposed value up-projection, a query up-projection, a query NoPE up-projection, or another projection applied to compressed latent vectors.

Continuing with FIG. 7, each processing device 116 of the plurality of processing devices 116 is configured to batch the one or more projection operations across a plurality of concurrent inference sessions to amortize weight reads from the local memory 122. By batching the projection operations across multiple concurrent inference sessions, each processing device 116 reads the projection weight matrices from the local memory 122 once per batch rather than once per session, reducing memory bandwidth consumption and increasing throughput of the multi-latent attention computation. In some embodiments, each processing device 116 batches the projection operations across 128 concurrent inference sessions. In some embodiments, the selected projection operations include a key up-projection and a value up-projection. In alternative embodiments, query projections, output projections, transposed key projections, transposed value projections, query NoPE projections, or combinations thereof are additionally or alternatively performed on the plurality of processing devices 116 to further reduce bandwidth consumption at the expense of increased processing load on the NPU cores 126.

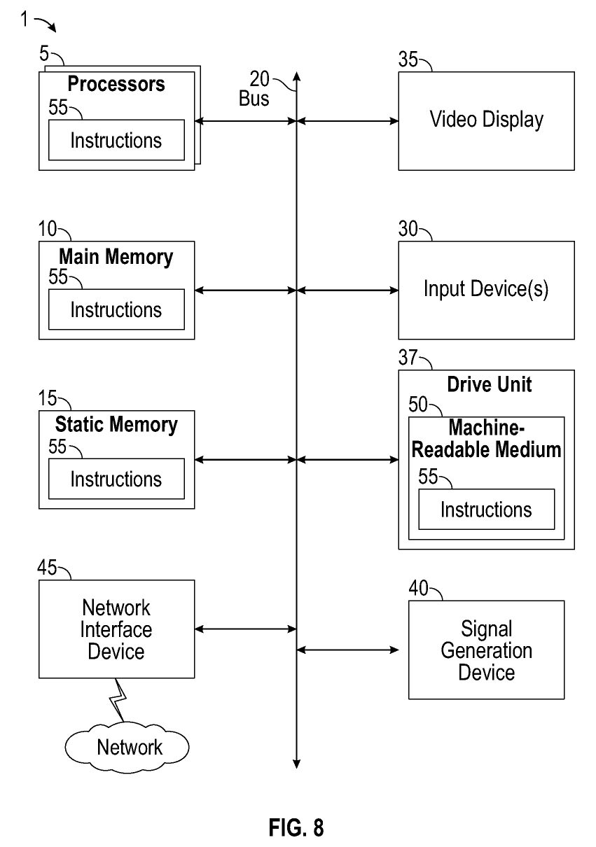

FIG. 8 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term "machine" shall also be taken to include any collection of machines that individually or jointly execute a set (or multiple sets) of instructions to perform any one or more of the methodologies discussed herein.

The computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term "computer-readable medium" should be taken to include a single medium or multiple media (e.g., a centralized or distributed database and/or associated caches and servers) that store the one or more sets of instructions. The term "computer-readable medium" shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term "computer-readable medium" shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

Where appropriate, the functions described herein can be performed in one or more of hardware, software, firmware, digital components, or analog components. For example, the systems and methods described herein can be embodied as one or more application specific integrated circuits (ASICs) or microcontrollers that can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

What is claimed is:

1. A method comprising:
storing, in a local memory of each processing device of a plurality of processing devices interconnected by an interconnection fabric, a respective portion of session state data for an inference session;
performing, at each processing device of the plurality of processing devices, an attention computation using the respective portion of the session state data stored in the local memory to generate a local partial result;
aggregating the local partial results from the plurality of processing devices through the interconnection fabric to produce a fully accumulated attention result, wherein the respective portions of the session state data remain stored in the local memory and do not traverse the interconnection fabric during the aggregating; and
outputting the fully accumulated attention result.

2. The method of claim 1, wherein each processing device of the plurality of processing devices comprises an application-specific integrated circuit (ASIC), the ASIC comprising a processing element configured to perform the attention computation.

3. The method of claim 1, wherein the aggregating comprises:
combining, at each processing device of the plurality of processing devices, the local partial result with an incoming partial result received from a preceding processing device of the plurality of processing devices through the interconnection fabric to produce an accumulated partial result; and
streaming the accumulated partial result from each processing device to a succeeding processing device of the plurality of processing devices through the interconnection fabric, wherein a final processing device of the plurality of processing devices outputs the fully accumulated attention result.

4. The method of claim 1, further comprising: transmitting the fully accumulated attention result to one or more compute processing units; and performing, via the one or more compute processing units, a feed-forward network computation using the fully accumulated attention result and model weights stored in a compute memory of the one or more compute processing units.

5. The method of claim 2, further comprising automatically detecting, via a firmware executing on each ASIC, a topology of the interconnection fabric and populating a routing table on each ASIC based on the detected topology without host software intervention.

6. The method of claim 3, further comprising:
generating, at each processing device of the plurality of processing devices, an error-correcting code (ECC) for the accumulated partial result; and
appending, at each processing device of the plurality of processing devices, a monotonically increasing sequence tag to the accumulated partial result prior to streaming the accumulated partial result to the succeeding processing device through the interconnection fabric.

7. The method of claim 3, further comprising, prior to the aggregating, writing a zeroed accumulator to a reserved memory region on a head processing device of the plurality of processing devices, resetting a sequence counter on the head processing device, and priming error-correcting code (ECC) bits for the zeroed accumulator via an ECC generator on the head processing device.

8. A system comprising:
a plurality of application-specific integrated circuits (ASICs) interconnected by an interconnection fabric, each ASIC of the plurality of ASICs comprising a processing element and a local memory configured to store session state data for an inference session; and
one or more compute processing units communicatively coupled to the plurality of ASICs, the one or more compute processing units configured to store model weights in a compute memory and perform feed-forward network computations, wherein each ASIC of the plurality of ASICs is configured to perform, via the processing element, an attention computation using the session state data stored in the local memory to generate a local partial result, combine the local partial result with an incoming partial result received from a preceding ASIC through the interconnection fabric to produce an accumulated partial result, and stream the accumulated partial result to a succeeding ASIC through the interconnection fabric, and wherein a final ASIC of the plurality of ASICs is configured to output a fully accumulated attention result to the one or more compute processing units.

9. The system of claim 8, wherein each ASIC of the plurality of ASICs is further configured to generate an error-correcting code (ECC) for the accumulated partial result and append a monotonically increasing sequence tag to the accumulated partial result prior to streaming the accumulated partial result to the succeeding ASIC through the interconnection fabric.

10. The system of claim 8, further comprising firmware executing on each ASIC of the plurality of ASICs, the firmware configured to automatically detect a topology of the interconnection fabric and populate a routing table on each ASIC based on the detected topology without host software intervention.

11. The system of claim 10, wherein the firmware is further configured to execute a fault-tolerant handshake protocol that detects a failure in a node or a link segment of the interconnection fabric and reconfigures the routing table to bypass the node or the link segment associated with the failure.

12. The system of claim 10, wherein the interconnection fabric supports a plurality of configurable topologies including a daisy chain, a double daisy chain, a grid topology, and a star topology, and wherein the firmware is configured to select a topology from the plurality of configurable topologies based on a physical link arrangement of the plurality of ASICs.

13. The system of claim 8, wherein each ASIC of the plurality of ASICs comprises: one or more processing cores, each processing core integrating a processing element core and a plurality of memory channels coupled to the local memory; and a write dispatcher configured to arbitrate between writes originated by the one or more processing cores and incoming traffic received from an adjacent ASIC of the plurality of ASICs through the interconnection fabric.

14. The system of claim 8, further comprising a host scheduler configured to, prior to an inference iteration, write a zeroed accumulator to a reserved memory region on a head ASIC of the plurality of ASICs, reset a sequence counter on the head ASIC, and prime error-correcting code (ECC) bits for the zeroed accumulator via an ECC generator on the head ASIC.

15. The system of claim 8, wherein the plurality of ASICs are disposed within a layer-3 network switch chassis, the layer-3 network switch chassis configured to be installed within data center switching infrastructure.

16. A system comprising:
a plurality of application-specific integrated circuits (ASICs) interconnected by an interconnection fabric, each ASIC of the plurality of ASICs comprising one or more processing cores and a write dispatcher, each chiplet of the one or more processing cores integrating a processing element core and a plurality of memory channels, the write dispatcher configured to arbitrate between writes originated by the one or more processing cores and incoming traffic received from an adjacent ASIC of the plurality of ASICs through the interconnection fabric, each ASIC of the plurality of ASICs further comprising a local memory coupled to the plurality of memory channels and configured to store session state data for an inference session;
one or more compute processing units communicatively coupled to the plurality of ASICs via a communication interface, the one or more compute processing units configured to store model weights for a feed-forward network of a language model in a compute memory; and
a firmware stored on each ASIC of the plurality of ASICs, the firmware configured to detect a physical topology of the interconnection fabric, populate a routing table on each ASIC based on the detected physical topology without host software intervention, and execute a fault-tolerant handshake protocol that detects a failure in a node or a link segment of the interconnection fabric and reconfigures the routing table to bypass the node or the link segment associated with the failure, wherein each ASIC of the plurality of ASICs is configured to read the session state data from the local memory, perform, via the one or more processing cores, an attention computation on the session state data to generate a local partial result, generate an error-correcting code (ECC) for the local partial result, append a monotonically increasing sequence tag to the local partial result, combine the local partial result with an incoming partial result received from a preceding ASIC through the interconnection fabric to produce an accumulated partial result, verify an error-correcting code and a sequence tag associated with the incoming partial result, and stream the accumulated partial result to a succeeding ASIC through the interconnection fabric, and wherein a final ASIC of the plurality of ASICs is configured to output a fully accumulated attention result to the one or more compute processing units via the communication interface for a feed-forward network computation.

17. The system of claim 16, wherein the interconnection fabric supports a plurality of configurable topologies selected from the group consisting of a daisy chain, a double daisy chain, a grid topology, and a star topology.

18. The system of claim 16, wherein each ASIC of the plurality of ASICs is further configured to perform, via the one or more processing cores, one or more projection operations on compressed latent vectors received from the one or more compute processing units via the communication interface to produce decompressed data for an attention computation, the one or more projection operations reducing bandwidth consumption for data transfers between the one or more compute processing units and the plurality of ASICs.

19. The system of claim 18, wherein each ASIC of the plurality of ASICs is configured to batch the one or more projection operations across a plurality of concurrent inference sessions to amortize weight reads from the local memory.

20. The system of claim 16, further comprising a software abstraction layer executing on a host processor, the software abstraction layer configured to expose an application programming interface (API) that enables a single instance of the language model to operate across the plurality of ASICs and the one or more compute processing units without model duplication.

21. The system of claim 16, wherein the interconnection fabric comprises a double daisy chain providing two parallel data paths between each pair of adjacent ASICs of the plurality of ASICs.
